(19) United States
(12) Patent Application Publication
(10) Pub. No.: US 2012/0001872 A1
(43) Pub. Date: Jan. 5, 2012

(54) ELECTRONIC BOOK READING DEVICE AND METHOD THEREOF

(75) Inventor: Bin GONG, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 12/939,184

(22) Filed: Nov. 4, 2010

(30) Foreign Application Priority Data
Jul. 1, 2010 (CN) 201010216421.X

(51) Int. Cl. G06F 3/042; G06F 3/041

(52) U.S. Cl. 345/175; 345/173

(57) ABSTRACT

An electronic book (E-book) reading device includes a screen, a sensor module, and a processing system. The sensor module senses a finger or a stylus passing by the sensor module and determines a movement direction of the finger or the stylus. The sensor module further outputs a detection signal according to each movement direction of the finger or the stylus. The processing system controls the screen according to the detection signals.

### BACKGROUND

1. Technical Field

The present disclosure relates to an electronic book reading device and a method of the electronic book reading device.

2. Description of Related Art

Electronic books are becoming more popular with the public. As opposed to books in paper form, electronic books are read on a corresponding electronic book reading device that displays pages of information just as they would appear in a paper book, thereby reducing costs of printing, binding, warehousing, and distributing. Electronic book reading devices have a user interface in the form of one or more buttons. The user is required to depress a selected button to flip over pages. However, this manner of operation can be awkward, and the user may feel bothered.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an electronic book reading device including a storage system.

FIG. 2 is a block diagram of the storage system of FIG. 2.

FIG. 3 is a flowchart of an exemplary embodiment of a method of the electronic book reading device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

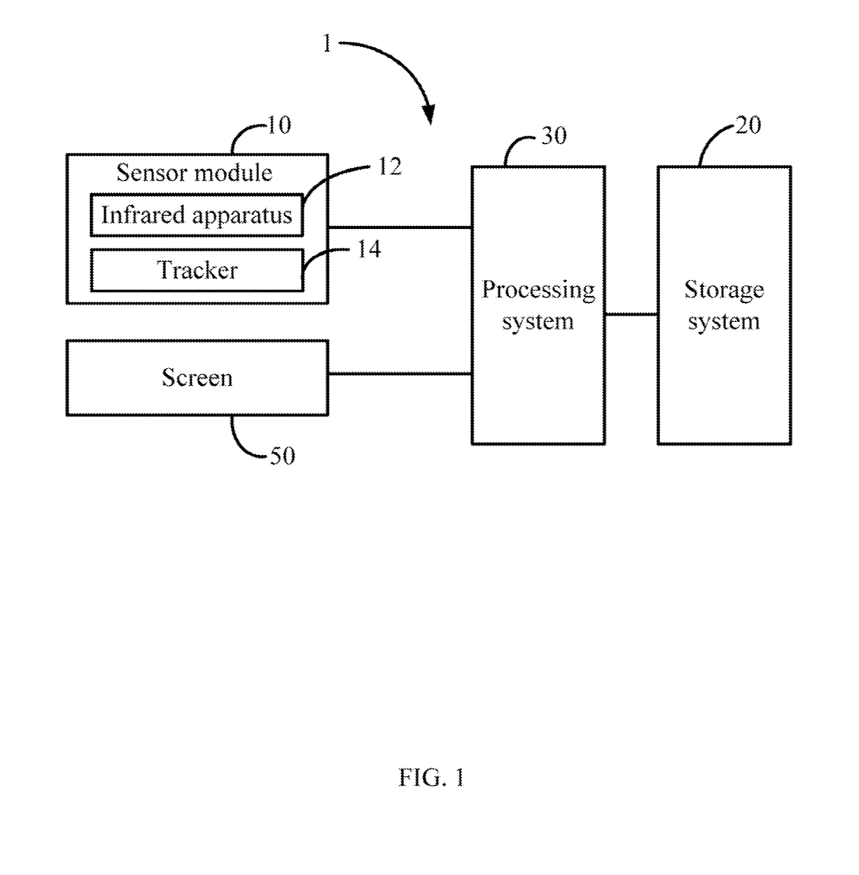

Referring to FIG. 1, an exemplary embodiment of an electronic book (E-book) reading device 1 includes a sensor module 10, a processing system 30, and a storage system 20. In addition, the E-book reading device 1 further includes a screen 50 and a power module (not shown in the figure). The sensor module 10 may be mounted nearby the screen 50.

The sensor module 10 includes an infrared apparatus 12 and a tracker 14. The infrared apparatus 12 senses the pass of a stylus or a finger. For example, when the finger or the stylus passes by the infrared apparatus 12, infrared rays emitted by the infrared apparatus 12 are reflected back to the infrared apparatus 12. At this time, the tracker 14 further determines the direction the finger or the stylus has moved. In the embodiment, the tracker 14 can recognize four directions, which include up, down, left, and right. The tracker 14 outputs a detection signal according to each direction the finger or the stylus moves.

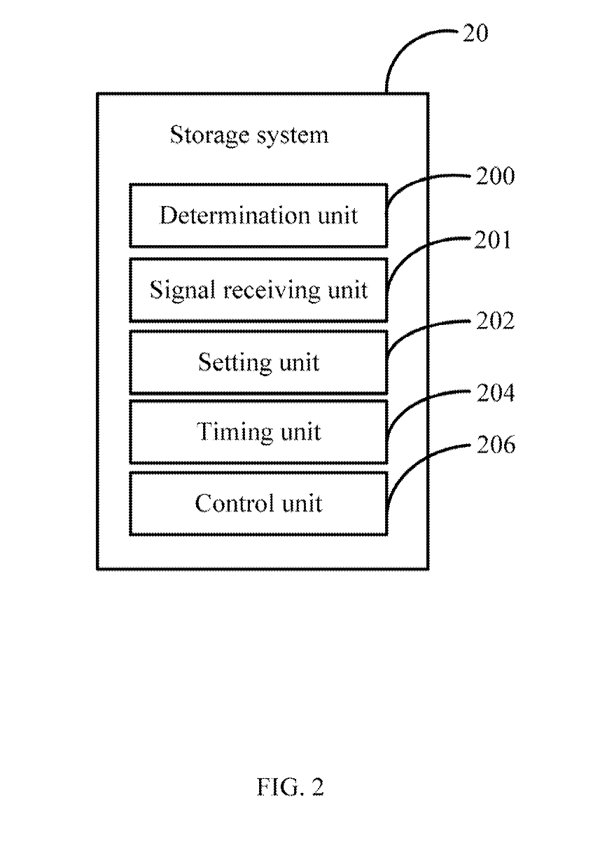

Referring to FIG. 2 also, the storage system 20 includes a determination unit 200, a signal receiving unit 201, a setting unit 202, a timing unit 204, and a control unit 206 which may include one or more computerized instructions and are executed by the processing system 30.

The setting unit 202 sets a period of time in the timing unit 204. When the period of time elapses, the timing unit 204 is reset and counts the time from zero. For example, if the period of time in the timing unit 204 is set to one second, the timing unit 204 will reset every one second.

The signal receiving unit 201 receives the detection signals from the tracker 14. The determination unit 200 counts the number of the detection signals and determines the type of each detection signal received by the signal unit 201 in every period of time. The type of the detection signal corresponds to the movement direction of the finger or the stylus sensed by the tracker 14. For example, when the finger or the stylus passes by the infrared apparatus 12 upward, the tracker 14 outputs a first detection signal. When the finger or the stylus passes by the infrared apparatus 12 downward, the tracker 14 outputs a second detection signal. When the finger or the stylus passes by the infrared apparatus 12 to the left, the tracker 14 outputs a third detection signal, when the finger or the stylus passes by the infrared apparatus 12 to the right, the tracker 14 outputs a fourth detection signal. In addition, when multiple fingers pass by the infrared sensor 12, the tracker 14 outputs a number of detection signals in turn according to the number of the fingers. For example, when two fingers pass by the infrared sensor 12 downward, the tracker 14 outputs two second detection signals in turn.

The control unit 206 controls the E-book reading device 1 according to the number and the types of the detection signals received by the signal receiving unit 201. For example, when the signal receiving unit 201 receives two first detection signals in a period of time, namely two fingers passing by the infrared apparatus 12 upward, the control unit 206 controls the screen 50 to page up two pages. When the signal receiving unit 201 receives only one second detection signal in the period of time, namely only one finger passes by the infrared apparatus 12 downward, the control unit 206 controls the screen 50 to page down one page. When the signal receiving unit 201 receives a third detection signal in the period of time, namely the finger passes by the infrared apparatus 12 to the left, the control unit 206 controls the screen 50 to return to the previous menu. When the signal receiving unit 201 receives a fourth detection signal in the period of time, namely the finger passes by the infrared apparatus 12 to the right, the control unit 206 controls the screen 50 to go to the submenu.

In the embodiment, the setting unit 202 can set a preset value N. In the embodiment, the preset value N may be equal to 5. When the signal receiving unit 201 receives three or more first detection signals in the period of time, the control unit 206 controls the screen 50 to page up for N pages. When the signal receiving unit 201 receives three or more second detection signals in the period of time, the control unit 206 controls the screen 50 to page down for N pages. Furthermore, if the detection signals received by the signal receiving unit 201 belong to different types, the control unit 206 does not work.

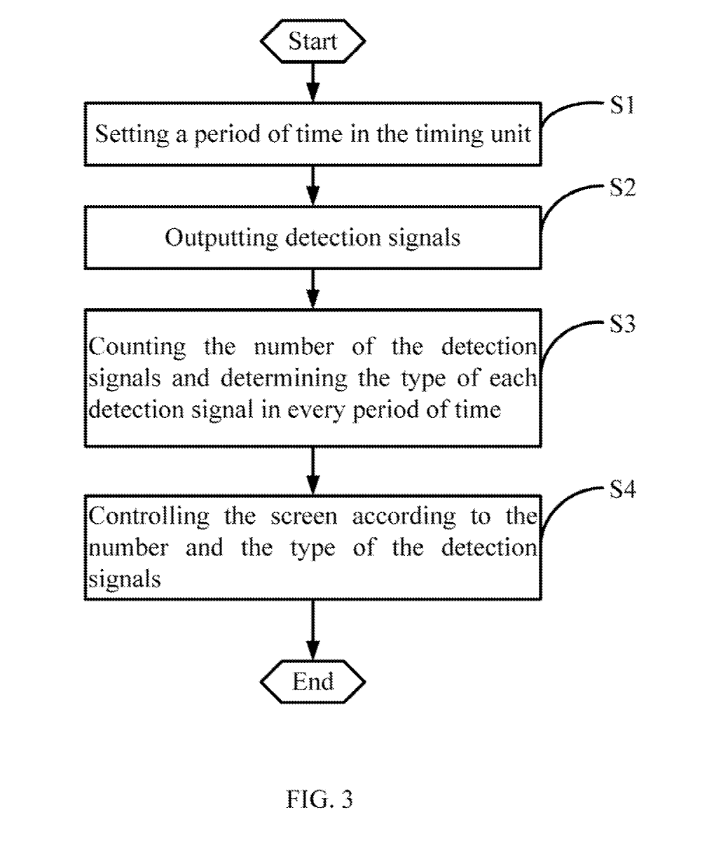

Referring to FIG. 3, an exemplary embodiment of a method of the E-book reading device 1 is as follows.

In step S1, the setting unit 202 sets a period of time in the timing unit 204. When the period of time elapses, the timing unit 204 is reset and counts the time from zero. Furthermore, the setting unit 202 further sets the preset value N. In the embodiment, the preset value N is equal to 5.

In step S2, the infrared apparatus 12 senses the finger(s) or the stylus, and the tracker 14 outputs detection signals according to the finger(s) or the stylus sensed by the infrared apparatus 12.

In step S3, the determination unit 200 counts the number of the detection signals and determines the type of the each detection signal received by the signal unit 201 in every period of time.

In step S4, the control unit 206 controls the screen 50 of the E-book reading device 1 according to the number and the type of the detection signals received by the signal receiving unit 201 in the period of time.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An electronic book (E-book) reading device comprising:
a screen;
a sensor module to sense a finger or a stylus passing by the sensor module and determine a moving direction of the finger or the stylus, wherein the sensor module outputs a detection signal according to each moving direction of the finger or the stylus;
a processing system connected to the sensor module; and
a storage system connected to the processing unit, and storing a plurality of programs to be executed by the processing unit to control the screen according to the detection signals.

2. The E-book reading device of claim 1, wherein when the finger or the stylus passes by the sensor module upward, the sensor module outputs a first detection signal; when the finger or the stylus passes by the sensor module downward, the sensor module outputs a second detection signal; when the finger or the stylus passes by the sensor module leftward, the sensor module outputs a third detection signal; when the finger or the stylus passes by the sensor module rightward, the sensor module outputs a fourth detection signal; and wherein when the processing system receives the first detection signal, the processing system controls the screen to page up for one page; when the processing system receives the second detection signal, the processing system controls the screen to page down for one page; when the processing system receives the third detection signal, the processing system controls the screen to return to a previous menu; when the processing system receives the fourth detection signal, the processing system controls the screen to go to a submenu.

3. The E-book reading device of claim 1, wherein the storage system comprises:
a timing unit;
a setting unit to set a period of time in the timing unit, wherein when the period of time elapses, the timing unit is reset and counting the time from zero again;
a signal receiving unit to receive the detection signals from the sensor module;
a determination unit to count the number of the detection signals and determine the type of each detection signal received by the signal receiving unit in every period of time; and
a controlling unit to control the screen according to the number and the type of the detection signals received by the signal receiving unit.

4. The E-book reading device of claim 3, wherein the setting unit further sets a preset value N, when the signal receiving unit receives three or more first detection signals in the period of time, the controlling unit controls the screen to page up for N pages; when the signal receiving unit receives three or more second detection signals in the period of time, the controlling unit controls the screen to page down for N pages.

5. The E-book reading device of claim 1, wherein the sensor module comprises:
an infrared apparatus to sense the stylus or a finger passing by the infrared apparatus; and
a tracker to determine the moving direction of the finger or the stylus, and output the detection signal according to each moving direction of the finger or the stylus.

6. A method of an electronic book (E-book) reading device comprising a screen and a sensor module, the method comprising:
sensing a finger or a stylus passing by the sensor module and determining a moving direction of the finger or the stylus;
outputting a detection signal according to each moving direction of the finger or the stylus; and
controlling the screen according to the detection signals.
